(19) United States
(12) Patent Application Publication
(10) Pub. No.: US 2011/0080554 A1
(43) Pub. Date: Apr. 7, 2011

(54) LIGHT EMITTING APPARATUS AND METHOD FOR MANUFACTURING LIGHT DEFLECTING LIQUID CRYSTAL CELL

(75) Inventor: Yasuo TOKO, Yokohama-shi (JP)

(73) Assignee: STANLEY ELECTRIC CO., LTD., Tokyo (JP)

(21) Appl. No.: 12/897,033

(22) Filed: Oct. 4, 2010

(30) Foreign Application Priority Data
Oct. 6, 2009 (JP) 2009-232308

(51) Int. Cl. G02F 1/13

(52) U.S. Cl. 349/193; 349/187

(57) ABSTRACT

A light emitting apparatus comprises a lamination of a first and a second light deflecting liquid crystal cells, a voltage applying device applying voltages to the light deflecting liquid crystal cells and an optical system irradiating incident light to the first light deflecting liquid crystal cell. Each cell comprises a prism layer having a prism extending in a predetermined direction, an alignment film formed on the prism layer and a liquid crystal layer having liquid crystal molecules. Long axis directions of the liquid crystal molecules are oriented in the predetermined direction on an interface between the alignment film and liquid crystal layer in the first cell and in a direction orthogonal to the predetermined direction in the second cell. The liquid crystal cells can change a course of light by deflecting both polarized light components of incident light.

This application is based on Japanese Patent Application 2009-232308, filed on Oct. 6, 2009, the entire contents of which are incorporated herein by reference.

### BACKGROUND OF THE INVENTION

A) Field of the Invention

This invention relates to a light emitting apparatus and a method for manufacturing a light deflecting liquid crystal cell and more specifically relates to a light emitting apparatus which deflects a course of light by a liquid crystal cell and a method for manufacturing the liquid crystal cell used in the light emitting apparatus.

B) Description of the Related Art

An incandescent lamp such as a halogen lamp or a high-intensity discharge (HID) lamp such as a metal halide lamp is widely used as a light source for a vehicle headlamp, which is one of lamps for a vehicle. Recently in a technical field of a vehicle headlamp, it has been considered to use a light emitting diode (LED) instead of using the incandescent lamp and the HID lamp. The LED is a light and small light source, has longer life and consumes lower electricity than the above-described conventional light sources; therefore, it is expected to be a new light source for a headlamp.

Two types of light distributions, i.e., driving beam and passing beam, are required for a vehicle headlamp. The following methods for switching the light distributions are known. As a first method for switching the distributions, two types light sources, one for driving beam and another for passing beam are switched in accordance with the light distributions. This method is widely used in a headlamp using an incandescent lamp. As a second method for switching the distributions, a movable light shielding part is used for switching the two types of distributions. This method is widely used in a headlamp using a HID lamp. However, it is necessary for using those switching methods to be equipped with two types of light sources or a movable light shielding part; therefore, a size and a weight of a headlamp becomes large and heavy.

In order to solve that problem, a switching method using a liquid crystal optical element has been suggested. For example, Japanese Laid-open Patent 2006-147377 (hereinafter patent document 1) discloses a technique for deflecting light by using a liquid crystal cell having a prism formed on an inner surface of one of a pair of substrates. By switching between applying a voltage and not applying a voltage, refractive index of a liquid crystal layer is changed to switch (deflect) a course of light. However, the technique disclosed by the patent document 1 can deflect only one polarized light component of light irradiating to a liquid crystal cell out of two polarized light components whose polarization directions are orthogonal to each other as disclosed in FIG. 10 and paragraphs [0053] and [0016] in the patent document 1.

Japanese Laid-open Patent 2009-026641 (hereinafter patent document 2) discloses a technique for bending much light toward one direction by overlaying two liquid crystal cells whose orientation directions are orthogonal to each other. However, the technique disclosed by the patent document 2 cannot bend the entire incident light and some light goes straight.

### SUMMARY OF THE INVENTION

It is an object of the present invention to provide a light emitting apparatus which can change a light emitting direction by using a liquid crystal cell to deflect both polarized light components of incident light.

According to one aspect of the present invention, there is provided a light emitting apparatus, comprising: a first light deflecting liquid crystal cell to which light irradiates, comprising a pair of a first and a second transparent substrate facing each other, a pair of a first and a second transparent electrodes formed on the first and the second transparent substrates and applying a voltage between the first and the second transparent substrates, a first prism layer formed on either one of the first and the second transparent substrate and having a prism extending in a first direction, a first alignment film formed on the first prism layer and to which an alignment process in the first direction is performed, and a first liquid crystal layer placed between the first and the second transparent substrates and having liquid crystal molecules whose long axis direction is oriented in the first direction on an interface between the first liquid crystal layer and the first alignment film; a second light deflecting liquid crystal cell to which the light passing through the first light deflecting liquid crystal cell irradiates, comprising a pair of a third and a fourth transparent substrate facing each other, a pair of a third and a fourth transparent electrodes formed on the third and the fourth transparent substrates and applying a voltage between the third and the fourth transparent substrates, a second prism layer formed on either one of the third and the fourth transparent substrate and having a prism extending in a first direction, a second alignment film formed on the second prism layer and to which an alignment process in a second direction orthogonal to the first direction is performed, and a second liquid crystal layer placed between the third and the fourth transparent substrates and having liquid crystal molecules whose long axis direction is oriented in the second direction on an interface between the second liquid crystal layer and the second alignment film; a voltage applying device that applies the voltages to the first to the fourth transparent electrodes; and an optical system that makes light irradiate to the first light deflecting liquid crystal cell.

According to another aspect of the present invention, there is provided a method for manufacturing a light deflecting liquid crystal cell, comprising the steps of: providing a pair of transparent substrates; forming a pair of transparent electrodes applying a voltage to the pair of transparent substrates on the pair of the transparent substrates; forming a prism layer having a prism extending in a first direction above one of the pair of the transparent substrate; forming an alignment film on the first prism layer; performing an alignment process in the first direction to the alignment film; bonding the pair of transparent substrates with a space between them; and filling liquid crystal into the space between the pair of transparent substrates.

According to the present invention, a light emitting apparatus which can change a light emitting direction by using a liquid crystal cell to deflect both polarized light components of incident light can be provided.

### BRIEF DESCRIPTION OF THE DRAWINGS

FIG. 1 is a schematic cross sectional view of a light deflecting liquid crystal cell according to a first embodiment of the present invention.

FIG. 2 is a schematic perspective view of a prism layer.

FIG. 3 is a schematic plan view of the prism layer.

FIG. 4A is a schematic perspective view of a laminated cell according to the embodiment, and FIG. 4B is a photograph of the laminated cell.

FIG. 5 is a schematic cross sectional view showing a light emitting apparatus according to the embodiment.

FIG. 6A and FIG. 6B are diagrams showing changes in a projection image of light by ON/OFF of the voltage when a circle luminous flux is irradiated to the laminated cell 25 according to the first embodiment of the present invention.

FIG. 7 is a schematic cross sectional view showing a light deflecting liquid crystal cell according to a second embodiment of the present invention.

### DETAILED DESCRIPTION OF THE PREFERRED EMBODIMENTS

An optical boundary is formed because a refractive index of a long axis of the liquid crystal molecules are higher than a refractive index of prism material when a liquid crystal layer is configured above a prism surface, the refractive index of the prism material and that of a short axis of the liquid crystal molecules are almost same and the refractive index of the long axis is higher than that of the short axis.

A shape of a liquid crystal molecule is long and narrow, and light polarized in a certain direction (a long axis direction of a liquid crystal molecule) can be bent (deflected) but light polarized in another direction (a short axis direction of a liquid crystal molecule) passes through without being bent. As a result bent (deflected) light is in a straight polarization state. Therefore, one sheet of the liquid crystal cell can only control half of incident light.

In a technique disclosed in a specification of Japanese Patent Application 2008-321402 invented by the inventor of the present invention, all the incident light can be controlled by laminating two liquid crystal cells and controlling orientation states of the second cell on an interface between a crystal liquid layer and a substrate near a plane of incidence to be parallel to a polarization direction of light which has not been bent by the first cell.

However, there slightly exists light which has not been bent by two cells by the above-described prior art. That is because an alignment film is not formed on a prism layer and an alignment process (rubbing) is performed directly to the prism layer. It is considered that the rubbed prism layer does not have sufficient liquid crystal orientation regulating power and so not all the liquid crystal molecules are oriented to a rubbing direction.

Although the orientation regulating power can be sufficient by forming an alignment film on the prism layer, a heat resisting property of material for forming a prism is low and so properties are deteriorated by a heat treatment process (180 to 220 degrees Celsius) for forming an alignment film made of polyimide, etc. The inventor of the present invention has performed experiments and found material for forming a prism layer, whose properties are not deteriorated by the heat treatment process for forming an alignment film.

In the experiments, differences in transmittances of a plurality of materials for forming a prism layer were examined before and after a heat treatment process (two hours at 220 degrees Celsius). As a result, ultraviolet ray (UV) curable acrylic resins showed the same transmittances before and after the heat treatment process almost all over the visible wavelength range although the transmittance after the heat treatment process was very slightly lowered at short wavelength side. The UV curable acrylic resins has not only heat resisting property but also has a property of good adherence to glass and good releasing ability to metal; therefore, it is preferable to use the UV curable acrylic resins as material for forming a prism layer according to the embodiments of the present invention.

Moreover, epoxy resins have good heat resisting property and can be also used as material for forming a prism layer according to the embodiments of the present invention. Furthermore, polyimide can be used as material for forming a prism layer according to the embodiments of the present invention.

An LCD alignment film made of polyimide or the likes can be formed on a prism layer by using material (to which a heat treatment process over 180 degrees Celsius and) whose properties (especially transmittance) are not greatly changed by a heat treatment process over 180 degrees Celsius. In this specification, a condition that properties (especially transmittance) are not greatly changed means a condition wherein change in the properties (especially transmittance) after the heat treatment process is about not over 2%.

The first embodiment of the present invention wherein a prism layer is formed by using the material whose properties (especially transmittance) are not greatly changed by a heat treatment process over 180 degrees Celsius (hereinafter heat resisting prism material) will be explained. In the first embodiment, a laminated cell was fabricated by laminating a first and a second light deflecting liquid crystal cells, each having a prism layer formed on one of a pair of ITO glass substrates by using the heat resisting prism material and an alignment film formed on the prism layer. Methods for fabricating the first and the second light deflecting liquid crystal cells are explained below. The methods are similar to each other unless otherwise explained.

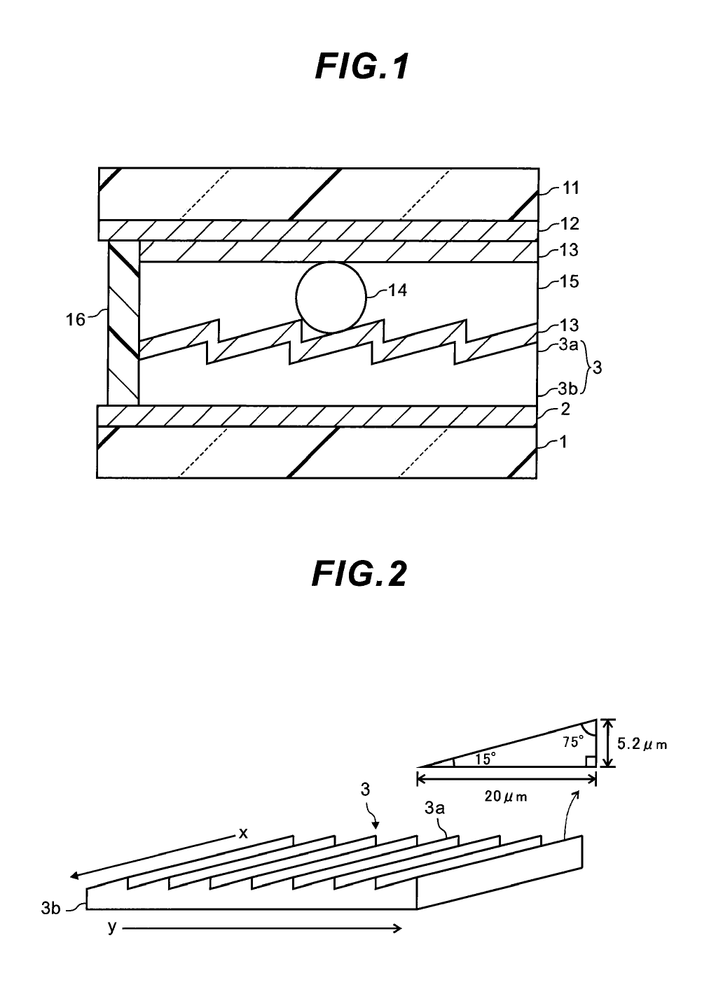

FIG. 1 is a schematic cross sectional view of a light deflecting liquid crystal cell according to a first embodiment of the present invention.

A pair of glass substrates on each of which transparent electrodes had been formed (a glass substrate 1 on which a transparent electrode 2 had been formed, a glass substrate 11 on which a transparent electrode 12 had been formed) were provided. The glass substrates 1 and 11 had thicknesses of 0.7 mmt and were made of non-alkaline glass. The transparent electrodes 2 and 12 had a thickness of 150 nm and were made of indium tin oxide (ITO) and patterned in a desired shape.

A prism layer 3 was formed on the transparent electrode 2 formed on the glass substrate 1. The prism layer 3 is in a shape wherein prisms 3a are aligned on a base layer 3b. A thickness of the base layer 3b is about 30 to 40 μm.

FIG. 2 is a schematic perspective view of the prism layer 3, and an enlarged view of a cross section of the prism 3a is shown on the right side. Each prism 3a is in a shape of a triangular prism having an apex angle of about 75 degrees and base angles of about 15 degrees and about 90 degrees. A plurality of the prisms 3a are aligned in a direction (hereinafter prism width direction) orthogonal to a direction in which the prisms 3a extend (hereinafter prism length direction). A height of the prism 3a is about 5.2 μm, and length of the base (a pitch) of the prism 3a is about 20 μm.

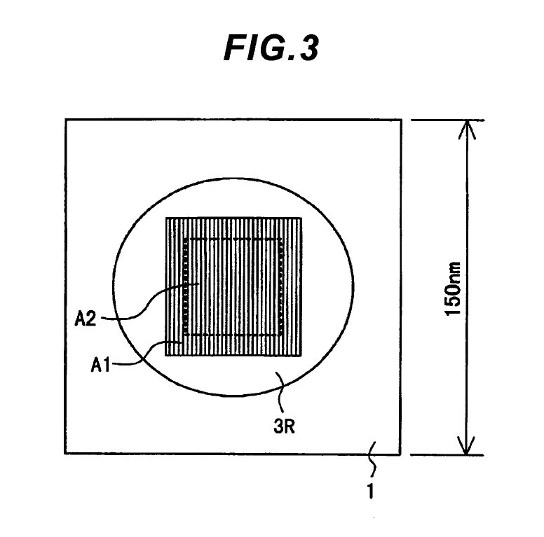

FIG. 3 is a schematic plan view showing the prism layer 3 above the glass substrate 1. First of all, a forming method of the prism layer 3 will be explained. A mold for the prism layer 3 was formed. Then, a predetermined amount of the heat resisting prism material 3R (e.g., UV curable acrylic resin) was dropped onto the prism mold coated with mold releasing agent or coating agent. Next, the transparent electrode 2 of the glass substrate 1 (150 mm long, 150 mm wide and 0.7 mmt thick) was placed on the prism mold, reinforced by placing a thick quartz on the back of the substrate 1 and pressed in that state. A size of the prism mold (a size of prism forming region) is 80 mm long and 80 mm wide.

The heat resisting prism material 3R was sufficiently spread by leaving the substrate pressed for over a minute, and thereafter the heat resisting prism material 3R was cured by 200 mJ/cm² of UV light. A radiating amount of UV can be arbitrary set to cure the resin. ITO has a property to absorb ultra violet ray so that the amount of radiating UV is necessary to be changed if a thickness of the transparent electrode is changed.

After the heat resisting prism material 3R was cured, the quartz and the pressing jig were removed and the glass substrate 1 was pushed up to release it from the prism mold.

A size of the prism layer 3 is adjusted by controlling the amount of dropping the heat resisting prism material 3R. The prism layer 3 was formed in the necessary region A2 (60 mm long and 60 mm wide) in whole prism forming region A1 (80 mm long and 80 mm wide) by adjusting the amount of dropping.

Return to FIG. 1 and the explanation will be continued. The glass substrate 1 with the prism layer 3 was cleaned by a cleaner. Brush cleaning with alkaline detergent, pure water cleaning, air-blow, UV radiation and IR dry were sequentially performed. A cleaning method is not limited to the above but high pressure spray cleaning, plasma cleaning, etc. can be used.

Thereafter, alignment films 13 were formed of polyimide, etc. on the transparent electrode 12 of another glass substrate 11 and on the prism layer 13 of the glass substrate 1. Each alignment film 13 was formed by forming a film having a thickness of 80 nm with SE-410 manufactured by Nissan Chemical Industries, LTD. by flexo-printing method and was baked for 1.5 hours at 180 degrees Celsius. After the baking, a rubbing process was performed to the alignment films 13. Rubbing directions of the alignment films 13 on the prism layer 13 of the glass substrate 1 and on the transparent electrode 12 of another glass substrate 11 were set anti-parallel when both glass substrates 1 and 11 were laminated to form a laminated cell.

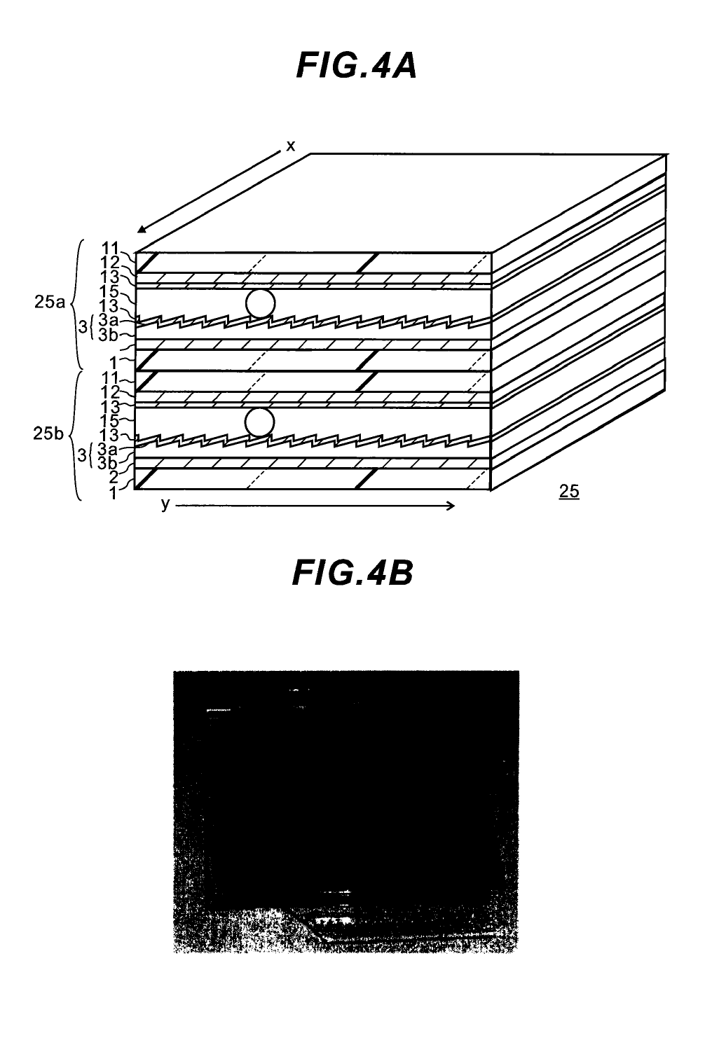

The rubbing process to the alignment film 13 on the prism layer 3 of the first light deflecting liquid crystal cell 25a (FIG. 4A) was performed in a direction x (the first direction) shown in FIG. 2 to make the long axis direction of the liquid crystal molecules aligned in parallel to a direction in which a ridge of the prism 3a extends (hereinafter prism direction).

The rubbing process to the alignment film 13 on the prism layer 3 of the second light deflecting liquid crystal cell 25b (FIG. 4A) was performed in a direction y (the second direction) 90 degrees rotated from the direction x shown in FIG. 2 to make the long axis direction of the liquid crystal molecules aligned orthogonal to the prism direction. That is, the rubbing process was performed from the left side to the right side in FIG. 1 and in a direction to climb up to the top of the prism 3a from the 15 degrees base angle in the cross sectional view.

That is, the rubbing process to the alignment film 13 on the prism layer 3 of the first light deflecting liquid crystal cell 25a (FIG. 4A) was performed in parallel to the prism direction, and the rubbing process to the alignment film 13 on the prism layer 3 of the second light deflecting liquid crystal cell 25b (FIG. 4A) was performed in orthogonal to the prism direction.

Next, a main seal pattern 16 containing 2 wt % to 5 wt % of gap controller was formed on the glass substrate 1 with the prism layer 3. Screen printing, dispenser or the likes is used for the formation of the main seal pattern 16. The gap controller was selected to make the liquid crystal layer 15 have a thickness of 10 to 15 μm including the thickness (2-30 μm) of the base layer 3b and the height (0 to 5 μm) of prism 3a. The height of the prism layer 3 varies from position to position and thereby the thickness of the liquid crystal layer 15 varies accordingly.

In this embodiment, plastic spheres in a diameter of 30 μm manufactured by Sekisui Chemical Co., LTD. were selected as the gap controller (spacer), and sealant ES-7500 manufactured by Mitsui Chemicals added with the 4 wt % of the gap controller was used as material for main seal pattern 16.

On the glass substrate 11 on which the prism layer 3 was not formed, plastic spheres in a diameter of 17 μm manufactured by Sekisui Chemical Co., LTD. as gap controller (spacer) 14 were sprayed by a dry type spacer spraying device.

Thereafter, both glass substrates 1 and 11 were laminated and a heat treatment process was performed to the laminated substrates 1 and 11 in a state that a predetermined pressure was given to the substrates. In this embodiment, the heat treatment process was performed at 150 degrees Celsius for three hours.

The liquid crystal layer 15 was formed by filling liquid crystal to the vacant cell fabricated by the above described processes. In this embodiment, liquid crystal with positive Δε and Δn=0.298 manufactured by DIC Corporation was used.

After filling the liquid crystal, end sealing material was applied to a filling port to seal it. After the sealing, heat treatment process was performed at 120 degrees Celsius for an hour to adjust the orientation of the liquid crystal molecules. By the above-described processes, two light deflecting liquid crystal cells 25a and 25b (FIG. 4A) were fabricated.

In the light deflecting liquid crystal cell according to the embodiment, the long axis of the liquid crystal molecule becomes along with the prism length direction when no voltage is applied and rises up in a direction perpendicular to the substrate when a voltage is applied. The liquid crystal used in the embodiment shows a refractive index of 1.823 to a polarized light component whose oscillation direction of electrical vector is in parallel to the long axis of the liquid crystal molecule whereas it shows a refractive index of 1.525 to a polarized light component whose oscillation direction of electrical vector is perpendicular to the long axis of the liquid crystal molecule.

A refractive index of the UV curable acrylic resin composing the prism layer 3 is 1.51 and similar to the refractive index to the polarized light component whose oscillation direction of electrical vector is perpendicular to the long axis of the liquid crystal molecule. In this specification, refractive indexes of the first and the second materials are considered to be similar if a difference between the refractive indexes is within 3% (more preferably 2%) of the refractive index of the first or the second material.

Further, the metal mold for forming the prism may have a micro groove for air to escape. The metal mold and the substrate may be laminated in vacuum. A liquid crystal filling method is not limited to a vacuum filling but also a one drop filling (ODF) method, etc. can be used.

In the light deflecting liquid crystal cell according to the embodiment, rectangle shaped electrode patterns which are crossing at 90 degrees with each other and wider than the prism pattern were formed on the lower and upper substrates 1 and 11 and terminals were formed on both substrates. Moreover, the electrodes of the lower and upper substrates 1 and 11 were not facing each other in the main seal part to restrain short circuit. If it is necessary to form a terminal only on one of the substrates, a structure wherein Au balls for conduction of both substrates are added to the main sealant can be adopted.

FIG. 4A is a schematic perspective view showing a laminated cell 25 according to the first embodiment. FIG. 4B is a photograph of the laminated cell according to the first embodiment.

The laminated cell 25 is a lamination of the first and the second light deflecting liquid crystal cells 25a and 25b by arranging them to make the length directions (the direction x or the first direction) of the prisms 3a parallel to each other in a plane, and by arranging them to make the inclined surfaces of the prisms incline in the same direction. Moreover, each cell 25a or 25b is arranged to make the substrate 11 without the prism layer 3 an upper substrate to which a light beam irradiate and the substrate 1 with the prism layer a lower substrate from which a light beam emits. The orientation of the liquid crystal molecules at an interface between the liquid crystal layer 15 and the alignment film 13 of the first light deflecting liquid crystal cell 25a is directed in the direction x (the first direction), and the orientation of the liquid crystal molecules at an interface between the liquid crystal layer 15 and the alignment film 13 of the second light deflecting liquid crystal cell 25b is directed in the direction y (the second direction). Therefore, the orientation directions of the first and the second light deflecting liquid crystal cells 25a and 25b are orthogonal to each other. Pin terminals (not shown) are connected to the electrodes of the first and the second light deflecting liquid crystal cells 25a and 25b to establish electrical continuity between them.

The inventor of this invention fabricated a first light emitting apparatus to be used as a headlamp for a vehicle by combining the laminated cell 25 with an optical system including a light source.

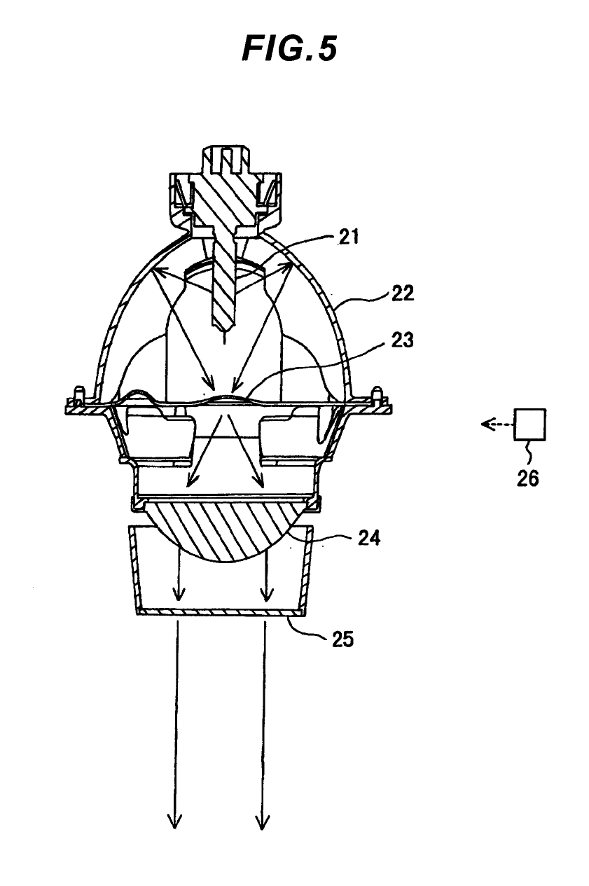

FIG. 5 is a schematic transverse (horizontal) cross sectional view of the first light emitting apparatus. A high-intensity discharge (HID) lamp was used as a light source 21. A light beam emitted from the light source 21 is reflected by an oval reflector 22 and concentrated to a shade 23 placed at a focal point of the oval reflector 22. The light beam transmitted through the shade 23 is almost collimated by a lens 24 and irradiated to the laminated cell 25. The light beam is emitted from the light emitting apparatus via the laminated cell 25. A voltage applying device 26 is electrically connected to the laminated cell 25 and switches voltages applied to the laminated cell 25. The laminated cell 25 is configured to make the prism direction horizontal when viewing the light emitting apparatus from a front.

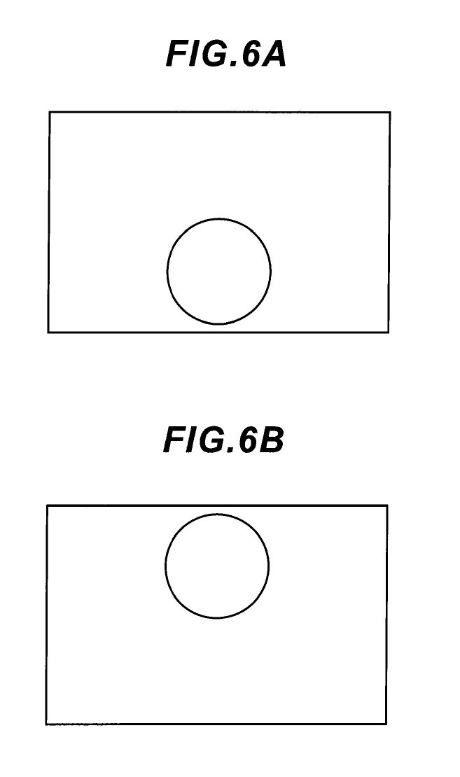

FIG. 6A and FIG. 6B are diagrams showing changes in a projection image of the light beam by ON/OFF of the voltage when a circle luminous flux is irradiated to the laminated cell 25 according to the first embodiment of the present invention.

As shown in FIG. 6A, when no voltage was applied (voltage OFF), the light beam went straight and a clear cut off pattern was projected. This situation corresponds to a low beam (passing beam) of a headlamp of a vehicle. The light beam dispersed in unnecessary directions such as stray light was not observed.

As shown in FIG. 6B, when a voltage was applied (voltage ON), the light beam (projected image) shifted upward. The light beam shifted about 6 degrees upward. Luminance was almost equal to the light beam when no voltage was applied. Moreover, no cut off pattern remained in a position where the cut off pattern was projected when no voltage was applied; therefore, it is considered that all the light beam transmitted through the laminated cell 25 was fully bent (deflected) by the laminated cell 25. Moreover, the shape of the projected image did not change even if the light beam (projected image) shifted upward, that is, translation of the light beam was observed.

Further, it is preferable to configure the laminated cell to make the prism direction horizontal in terms of a fail-safe although it is possible to switch between a low beam and a high beam if the laminated cell 25 is configured upside down.

In the above described experiment, the projected image was not continuously shifted upward when the applied voltage was gradually increased but shifted upward with slightly expanding its shape upward and downward, and the projected image was formed clearly when a high voltage (not less than 20V, 150 Hz) was applied. It is considered that the reason is as follows. The prism layer 3 exists between the ITO electrode on the substrates and the liquid crystal layer 15 so that a thickness of the liquid crystal layer 15 varies from position to position, and a voltage applied to the liquid crystal substantially varies from position to position.

A second embodiment of the present invention will be explained. In the first embodiment, the ITO pattern is formed below the prism layer 3; however, the ITO pattern is formed above the prism layer 3 in this second embodiment. It was difficult to form an ITO pattern on a prism layer with conventional material due to poor heat resisting property of the material. The inventor of the present invention has confirmed that a liquid crystal device can be fabricated without problem by forming a prism with the heat resisting prism material also used in the first embodiment and sputtering ITO on the prism layer.

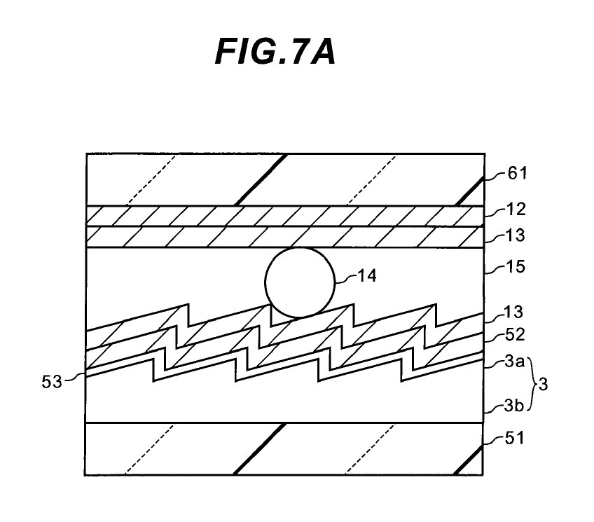

FIG. 7 is a schematic cross sectional view showing a light deflecting liquid crystal cell according to the second embodiment of the present invention.

Two pairs of glass substrates (glass substrate 51 and glass substrate 61 with a transparent electrode 12) were provided. The glass substrates 51 and 61 are made of soda-lime glass and their thicknesses are 0.7 mmt. The transparent electrode 12 was formed on the glass substrate 61 and made of indium tin oxide (ITO) with a thickness of 150 nm.

First, a prism layer 3 shown in FIG. 2 and FIG. 3 was formed on the glass substrate 51 by the similar processes in the first embodiment. For example, a predetermined amount of the heat resisting prism material 3R (e.g., UV curable acrylic resin) was dropped onto the prism mold coated with mold releasing agent or coating agent. Next, the glass substrate 51 (150 mm long, 150 mm wide and 0.7 mmt thick) was placed on the prism mold, reinforced by placing a thick quartz on the back of the substrate 51 and pressed in that state. A size of the prism mold (a size of prism forming region) is 80 mm long and 80 mm wide. The heat resisting prism material 3R was sufficiently spread by leaving the substrate pressed for over a minute, and thereafter the heat resisting prism material 3R was cured by UV light to form the prism layer 3.

Next, an ITO film 52 was formed on the prism layer 3. The glass substrate 51 with the prism layer 3 was cleaned by a cleaner. Brush cleaning with alkaline detergent, pure water cleaning, air-blow, UV radiation and IR dry were sequentially performed. A cleaning method is not limited to the above but high pressure spray cleaning, plasma cleaning, etc. can be used.

The ITO film 52 would be formed directly on the prism layer 3 without a problem, but a thin SiO₂ film 53 was formed between the prism layer 3 and the ITO film 52 for improving adherence by a sputtering method (alternating current discharge). The substrate was heated at 80 degrees Celsius and the SiO₂ film 53 was formed with a thickness of 50 nm.

Thereafter, the ITO film 52 was formed on the SiO₂ film 53 by the sputtering method (alternating current discharge). The substrate was heated at 100 degrees Celsius and the ITO film 52 was formed with a thickness of 100 nm. At this time a SUS mask, etc. may be used not to form an ITO film on unnecessary regions. The formation method is not limited to the sputtering method but a vacuum deposition, an ion beam method, chemical vapor deposition (CVD) method, etc. can be used.

Next, the ITO film 52 on the glass substrate 61 was patterned into a desired pattern. The glass substrate 61 with the ITO film 52 was cleaned by a cleaner by the similar cleaning method as the glass substrate 51, and a patterning process was performed by using a well-known photolithography process. Wet-etching (ferric oxide) was used as an etching method in this embodiment.

Then, the glass substrate 51 with the prism layer 3 and the glass substrate 61 with the ITO pattern were cleaned by a cleaner. Brush cleaning with alkaline detergent, pure water cleaning, air-blow, UV radiation and IR dry were sequentially performed. A cleaning method is not limited to the above but high pressure spray cleaning, plasma cleaning, etc. can be used.

Alignment films 13 made of polyimide, etc. were formed on the prism layer 3 and on the transparent electrode 12 of the glass substrate 61 by the similar processes as the first embodiment. The forming method, the heat treatment process and the rubbing process for the alignment films 13 are the similar to the first embodiment so that their explanations are omitted.

Next, a main seal pattern 16 containing 2 wt % to 5 wt % of gap controller was formed on the glass substrate 51 with the prism layer 3, and plastic spheres in a diameter of 17 μm manufactured by Sekisui Chemical Co., LTD. as gap controller (spacer) 14 were sprayed by a dry type spacer spraying device. Thereafter, both glass substrates 51 and 61 were laminated and the heat treatment process was performed to the laminated substrates 51 and 61 in a state that a predetermined pressure was given to the substrates to harden the main seal pattern 16.

The liquid crystal layer 15 was formed, similar to the first embodiment, by filling liquid crystal to the vacant cell fabricated by the above described processes. In this embodiment, liquid crystal with positive Δε and Δn=0.298 manufactured by DIC Corporation was used. After filling the liquid crystal, end sealing material was applied to a filling port to seal it. After the sealing, heat treatment process was performed at 120 degrees Celsius for an hour to adjust the orientation of the liquid crystal molecules. By the above-described processes, two light deflecting liquid crystal cells were fabricated.

The inventor of this invention laminated the fabricated two light deflecting liquid crystal cells according to the second embodiment and fabricated a second light emitting apparatus to be used as a headlamp for a vehicle by combining the laminated cell 25 with an optical system including a light source similar to the first embodiment. A structure of the second light emitting apparatus is similar to the light emitting apparatus shown in FIG. 5 according to the first embodiment except the laminated cell 25 is replaced with the laminated cell 25 according to the second embodiment.

As shown in FIG. 6A, when no voltage was applied (voltage OFF), the light beam went straight and a clear cut off pattern was projected also in the second embodiment. This situation corresponds to a low beam (passing beam) of a headlamp of a vehicle. The light beam dispersed in unnecessary directions such as stray light was not observed. Moreover, as shown in FIG. 6B, when a voltage was applied (voltage ON), the light beam (projected image) shifted upward. The light beam shifted about 6 degrees upward. Luminance was almost equal to the light beam when no voltage was applied. Furthermore, no cut off pattern remained in a position where the cut off pattern was projected when no voltage was applied; therefore, it is considered that all the light beam transmitted through the laminated cell 25 was fully bent (deflected) by the laminated cell 25. Moreover, the shape of the projected image did not change even if the light beam (projected image) shifted upward, that is, translation of the light beam was observed. Further, it is preferable to configure the laminated cell to make the prism direction horizontal in terms of a fail-safe although it is possible to switch between a low beam and a high beam if the laminated cell 25 is configured upside down.

In the experiment using the laminated cell 25 according to the second embodiment, the projected image shifted upward continuously as the applied voltage gradually increased. At that time the applied voltage was about 5V and it was sufficient. This is because the prism layer 3 does not exist between the transparent electrode 52 on the substrate 51 and the liquid crystal layer 15, and the voltage can be applied directly to the liquid crystal. Moreover, it is considered that is because threshold value of the anti-parallel orientation of the nematic liquid crystal used in the second embodiment hardly depends on the thickness of the liquid crystal cell, and the refractive index at an interface with the prism hardly changes depending on positions even if the thickness of the liquid crystal layer changes from position to position.

In the experiment, the projected image started to shift from 2.5V and completed the shift at 4V. Between the voltages, gradual translation of the projected image while keeping its shape was observed. From that, the second embodiment can lower the voltage to bend light beam and continuously control light distributions. Therefore, the second embodiment can be used for an auto-leveling mechanism.

As described in the above embodiments, the light emitting apparatus according to the embodiments of the present invention can shift a course of a light beam by switching on and off a voltage applied to the light deflecting liquid crystal cells without mechanical moving parts. Further in the above described embodiments, switching a course of a light beam in two ways by on and off of the voltage was mainly explained; however, the course of a light beam can be continuously controlled by applying intermediate voltages as in the second embodiment.

Moreover, all the light beams transmitting though the liquid crystal device (laminated cell 25) can be bent. Angle of bending the light beams can be changed up to 6 degrees with the structures in the embodiments although it depends on a structure of the cells (a shape of the prism, refractive index anisotropy, etc.). For example, when one of the base angle of the prism 3s is increased to about 45 degrees, it is estimated that the course of the light beams can be shifted by about 18 degrees. A necessary range of shifting the course of the light beams for a headlamp of a vehicle is about 3 to 5 degrees for switching high/low beams, about 3 degrees for an auto-leveling mechanism, and about 15 degrees for an adaptive front lighting system (AFS); therefore, the light emitting apparatuses according to the embodiments have sufficient performance.

Although in the above describe embodiments the substrate without the prism is configured near the light source and the substrate with the prism is configured away from the light source for both light deflecting liquid crystal cells, it is possible to bend a light beam with the opposite configuration. That is, the substrate with the prism can be configured near the light source and the substrate without the prism can be configured away from the light source.

The light deflecting liquid crystal cells and the laminated cell according to the embodiments have higher transmittances than a liquid crystal optical device using a polarizer. It is estimated that each cell has light transmittance of no less than 90% or light transmittance of no less than 95% with an anti-reflective coating, and that the laminated cell has light transmittance of 80 to 90%.

Although a triangular prism shaped prism with the base angles of 15 degrees and 90 degrees is used in the above embodiments, the base angles are not limited to those. An inclined surface rising from the substrate at a loose angle works as a prism for an incident beam of light irradiated perpendicularly into the substrate, and a surface perpendicular to the substrate does not work as a prism for the incident beam of the light. By that structure, each cell can shift (bend) a course of a light beam in one direction. One of the base angles of the triangular prism shape is preferably in a range of 5 to 60 degrees and another angle is preferably in a range of 85 to 90 degrees.

Moreover, in the above embodiments, the pitch of the triangular prism shaped prism is 20 μm. It is preferable for the pitch of the prism to be a range of 1 to 100 μm.

Moreover, for example, the shape of the prism may have a cross-section in a sine curved shape other than that shown in the embodiments. Further, in the embodiments a top surface shape of the prism layer is stripe, but the top surface shape may be in a shape of a lattice, concentric circles, an oval, a Fresnel lens, dots, etc. Furthermore, the shapes of the prisms of the first and the second light deflecting liquid crystal cells may be different form each other.

The light source for the light emitting apparatuses according to the embodiments may be a light emitting diode (LED), a field emission (FE) light source, a fluorescent lamp, etc. other than the HID lamp.

For example, the light emitting apparatuses according to the embodiments may be applied to lightings (headlamps, auxiliary lamps, fog lamps, cornering lamps, etc.) for four-wheeled vehicles (cars, trucks, busses, etc.) and to lightings (a light distribution controller) for two-wheeled vehicles (a motorcycle, a bicycle, etc.). Moreover, the embodiments can be applied to general lighting equipments such as indoor illumination, a street light, a flashlight, etc.

The present invention has been described in connection with the preferred embodiments. The invention is not limited only to the above embodiments. It is apparent that various modifications, improvements, combinations, and the like can be made by those skilled in the art.

What are claimed are:

1. A light emitting apparatus, comprising:
a first light deflecting liquid crystal cell to which light irradiates, comprising a pair of a first and a second transparent substrate facing each other, a pair of a first and a second transparent electrodes formed on the first and the second transparent substrates and applying a voltage between the first and the second transparent substrates, a first prism layer formed above either one of the first and the second transparent substrate and having a prism extending in a first direction, a first alignment film formed on the first prism layer and to which an alignment process in the first direction is performed, and a first liquid crystal layer placed between the first and the second transparent substrates and having liquid crystal molecules whose long axis direction is oriented in the first direction on an interface between the first liquid crystal layer and the first alignment film;
a second light deflecting liquid crystal cell to which the light passing through the first light deflecting liquid crystal cell irradiates, comprising a pair of a third and a fourth transparent substrate facing each other, a pair of a third and a fourth transparent electrodes formed on the third and the fourth transparent substrates and applying a voltage between the third and the fourth transparent substrates, a second prism layer formed above either one of the third and the fourth transparent substrate and having a prism extending in a first direction, a second alignment film formed on the second prism layer and to which an alignment process in a second direction orthogonal to the first direction is performed, and a second liquid crystal layer placed between the third and the fourth transparent substrates and having liquid crystal molecules whose long axis direction is oriented in the second direction on an interface between the second liquid crystal layer and the second alignment film;
a voltage applying device that applies the voltages to the first to the fourth transparent electrodes; and
an optical system that makes light irradiate to the first light deflecting liquid crystal cell.

2. The light emitting apparatus according to claim 1, wherein the first prism layer is formed on either one of the first and the second transparent electrodes, and the second prism layer is formed on either one of the third and the fourth transparent electrodes.

3. The light emitting apparatus according to claim 1, wherein the first prism layer is formed between the first transparent substrate and the first transparent electrode or between the second transparent substrate and the second transparent electrode, and the second prism layer is formed between the third transparent substrate and the third transparent electrode or between the fourth transparent substrate and the fourth transparent electrode.

4. The light emitting apparatus according to claim 1, wherein the first and the second prism layer are made of material capable of withstanding a heat treatment process at a temperature of not less than 180 degrees Celsius.

5. The light emitting apparatus according to claim 1, wherein main surfaces of the first and the second light deflecting liquid crystal cells are perpendicular to a ground surface, and the first direction is parallel to the ground surface.

6. The light emitting apparatus according to claim 1, wherein the first and the second prism layers have a structure wherein prisms in a shape of a triangular prism having a base angle of 5 to 60 degrees and a base angle of 85 to 95 degrees are aligned in a same direction.

7. The light emitting apparatus according to claim 1, wherein a refractive index of the first prism layer and a refractive index of the first liquid crystal layer for a polarized light component whose oscillating direction of an electric vector is perpendicular to the long axis direction of the liquid crystal molecules are similar, and a refractive index of the second prism layer and a refractive index of the second liquid crystal layer for a polarized light component whose oscillating direction of an electric vector is perpendicular to the long axis direction of the liquid crystal molecules are similar.

8. The light emitting apparatus according to claim 1, wherein
the first and the second prism layers are made of transparent material having similar refractive indexes, and
the first and the second liquid crystal layers are formed of liquid crystal material having similar refractive indexes for a polarized light component whose oscillating direction of an electric vector is parallel to the long axis direction of the liquid crystal molecules and also for a polarized light component whose oscillating direction of an electric vector is perpendicular to the long axis direction of the liquid crystal molecules.

9. The light emitting apparatus according to claim 1, wherein the optical system comprises a light emitting diode as a light source.

10. A method for manufacturing a light deflecting liquid crystal cell, comprising the steps of:
providing a pair of transparent substrates;
forming a pair of transparent electrodes applying a voltage to the pair of transparent substrates on the pair of the transparent substrates;
forming a prism layer having a prism extending in a first direction above one of the pair of the transparent substrate;
forming an alignment film on the first prism layer;
performing an alignment process in the first direction to the alignment film;
bonding the pair of transparent substrates with a space between them; and
filling liquid crystal into the space between the pair of transparent substrates.
